(19) United States
(12) Patent Application Publication
(10) Pub. No.: US 2025/0193784 A1
(43) Pub. Date: Jun. 12, 2025

(54) APPLICATION AND NETWORK SLICE MAPPING SERVICE

(71) Applicant: Verizon Patent and Licensing Inc., Basking Ridge, NJ (US)

(72) Inventors: Jay J. Lee, San Ramon, CA (US); Shanthala Kuravangi-Thammaiah, Keller, TX (US)

(21) Appl. No.: 18/536,981

(22) Filed: Dec. 12, 2023

(51) Int. Cl. H04W 48/18; H04W 72/54

(52) U.S. Cl. CPC H04W 48/18; H04W 72/54

(57) ABSTRACT

A method, an end device, and a non-transitory computer-readable storage medium are described in relation to an application and network slice mapping service. The application and network slice mapping service may include mapping an end device application to multiple application categories of the connection capabilities component of the traffic descriptors associated with route selection policies. For example, the end device application may be separated into multiple application traffic characteristics or different application categories. The mapping service may map the application categories to one or multiple network slices. The mapping service may assign a quality of service identifier value to each application category. The mapping service may apply a scheduling algorithm to the application categories that share the same network slice.

### BACKGROUND

Development and design of networks present certain challenges from a network-side perspective and an end device perspective. For example, wireless networks, such as Fifth Generation New Radio (5G NR) networks are being deployed and are under development. End devices may connect to a radio access network (RAN) and a core network according to various types of configurations and may be afforded different quality of service (QoS) levels.

### BRIEF DESCRIPTION OF THE DRAWINGS

FIG. 1 is a diagram illustrating an exemplary environment in which an exemplary embodiment of an application and network slice mapping service may be implemented;

FIG. 2 is a diagram illustrating exemplary components of a network device that provide an exemplary embodiment of the application and network slice mapping service;

FIG. 3 is a diagram illustrating exemplary components of a device that may correspond to one or more of the devices illustrated and described herein; and

FIG. 4 is a diagram illustrating an exemplary process of an exemplary embodiment of the application and network slice mapping service.

### DETAILED DESCRIPTION

The following detailed description refers to the accompanying drawings. The same reference numbers in different drawings may identify the same or similar elements. Also, the following detailed description does not limit the invention.

Network slicing is a network configuration that allows multiple networks (e.g., virtualized and independent) to be created on top of a common physical network, such as a RAN and a core network. An end device, such as user equipment (UE) may store a UE route selection policy (URSP) that the end device may use to determine how to route outgoing traffic in the network and manage network slice information. The end device may select a network slice via which a packet data unit (PDU) session may be set up based on the URSP information and an end device application associated with the PDU session.

According to a network standard, single network slice selection assistance information (S-NSSAI) may identify a network slice. The S-NSSAI may include slice/service type (SST) information and (optionally) slice differentiator (SD) information. For example, the SST information may be represented by 8 bits and may indicate a total of 255 different slice types (e.g., enhanced Mobile Broadband (eMBB), ultra reliable low latency communications (URLLC), massive Internet of Things (MioT), etc.). The SD information may be represented by 24 bits and may be used as an additional differentiator if multiple network slices carry the same SST value, for example. Several S-NSSAIs may form a group or collection called NSSAI. In a 5G network, the network slice selection policy can be dynamically configured through URSP, and new services may be configured for the end device.

Under a network standard defined by a standards body, such as Third Generation Partnership Project (3GPP), the URSP may include multiple rules for traffic flows and routing. A rule may include a traffic descriptor and a route selection descriptor. The traffic descriptor may include information identifying which traffic flow is associated with which network slice, radio access technology (RAT), core network, and other routing parameters. The traffic descriptor in a URSP rule may include various parameters, such as application descriptors, domain descriptors, non-IP descriptors, data network name (DNN), and/or connection capabilities, for example. For each traffic descriptor, at least one component of the route selection descriptor is present. For example, there may be various types of route selection descriptor parameters, such as route selection descriptor precedence, session and service continuity (SSC) mode, network slice selection, DNN selection, access type preference, multi-access preference, and so forth.

The mapping between applications and network slices so that the network may provide appropriate treatment and satisfy their performance requirements, such as latency, jitter, packet loss ratio, throughput, and other performance metric parameters is an important aspect of connectivity between the end device and the network. A default URSP mapping is when a single application is mapped to a single application category in the connection capabilities (associated with the traffic descriptor), which is in turn mapped to an S-NSSAI.

However, a single category mapping can lead to wasteful use of network resources and QoS issues. For example, IoT applications may have a wide range of traffic requirements relative to delay (e.g., low delay to high delay), reliability (e.g., low reliability to ultra-high reliability), as well as other performance metrics (e.g., packet error, throughput, priority, bitrate, etc.) depending on its use case. Similarly, gaming applications may have a wide range of traffic requirements, such as gaming with low latency, gaming with interactive communication (e.g., voice and/or video), gaming with streaming, gaming with download, gaming with augmented reality (AR) or virtual reality (VR), gaming with artificial intelligence (AI), and so forth. In this regard, the single category mapping may allow a network slice that supports higher performance metric demands (e.g., delay, throughput, reliability, etc.) than may be needed by the end device application, which results in a waste of network resources. Alternatively, the single category mapping may allow a network slice that supports lower performance metric demands than may be needed by the end device application, which results in poor QoS experience for a user, inability to satisfy service level agreement (SLA) requirements, and the like. Accordingly, there is a need in the art to address URSP mapping of applications to network slices.

According to exemplary embodiments, an application and network slice mapping service is described herein. According to an exemplary embodiment, the application and network slice mapping service may include mapping between end device applications and network slices, as described. The application and network slice mapping service may include establishment of a connection between an end device and a network based on the mapping, as described herein.

According to an exemplary embodiment, the application and network slice mapping service may include mapping an end device application to multiple application categories of the connection capabilities component of the traffic descriptor, as described herein. According to an exemplary embodiment, the end device application may be separated into multiple application traffic characteristics. The application and network slice mapping service may map each application traffic characteristic to an application category in which at least some of the application traffic characteristics may be assigned different application categories of the connection capabilities component of the traffic descriptor included in URSP information. According to an exemplary embodiment, the application and network slice mapping service may use known application categories and operator-specific connection capabilities (e.g., operator created or defined), as described herein.

According to various exemplary embodiments, the application and network slice mapping service may map the application traffic characteristics to a single network slice or multiple network slices based on the route selection descriptor, as described herein.

According to an exemplary embodiment, the application and network slice mapping service may assign a 5G QoS identifier (5QI) value to each application traffic characteristic and/or application category of the end device application in relation to a traffic flow (e.g., 5G QoS flow) and the network slice, as described herein. The 5QI values may include standardized and non-standardized values (e.g., operator-specific configurations).

According to an exemplary embodiment, the application and network slice mapping service may apply a scheduling algorithm to the application categories when a single network slice is used to support multiple application categories, as described herein. In this way, the end device application may be afforded appropriate treatment for the required performance requirements.

In view of the foregoing, the application and network slice mapping service may improve network resource utilization associated with network slices in a network, such as a RAN and a core network. Additionally, the application and network slice mapping service may improve the granularity of application and network slice mapping based on the multiple application category-based mapping, as described herein.

Further, the application and network slice mapping service may improve QoS, quality of experience (QoE), key performance indicator (KPI), mean opinion score (MOS), adherence to SLA requirements and the like relating to network slice selection and support of QoS flows within a PDU session via the network slice.

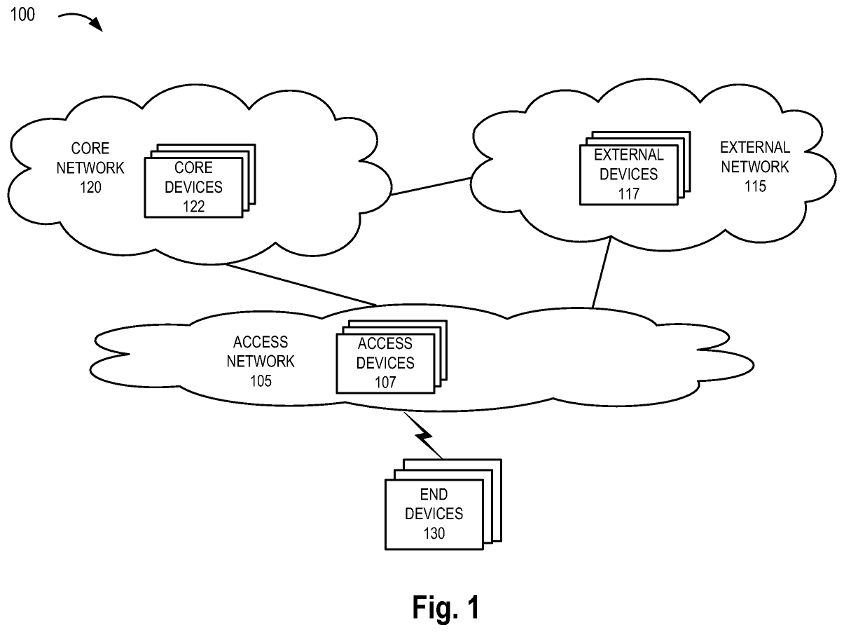

FIG. 1 is a diagram illustrating an exemplary environment 100 in which an exemplary embodiment of an application and network slice mapping service may be implemented. As illustrated, environment 100 includes an access network 105, an external network 115, and a core network 120. Access network 105 includes access devices 107 (also referred to individually or generally as access device 107). External network 115 includes external devices 117 (also referred to individually or generally as external device 117). Core network 120 includes core devices 122 (also referred to individually or generally as core device 122). Environment 100 further includes end devices 130 (also referred to individually and generally as end device 130).

The number, type, and arrangement of networks illustrated in environment 100 are exemplary. For example, according to other exemplary embodiments, environment 100 may include fewer networks, additional networks, and/or different networks. For example, according to other exemplary embodiments, other networks not illustrated in FIG. 1 may be included, such as an X-haul network (e.g., backhaul, mid-haul, fronthaul, etc.), a transport network (e.g., Signaling System No. 7 (SS7), etc.), or another type of network that may support a wireless service and/or an application service, as described herein.

A network device, a network element, or a network function (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, fog, and/or another type of computing architecture, and may be incorporated into distinct types of network architectures (e.g., Software Defined Networking (SDN), client/server, peer-to-peer, etc.) and/or implemented with various networking approaches (e.g., logical, virtualization, network slicing, etc.). The number, the type, and the arrangement of network devices are exemplary.

Environment 100 includes communication links between the networks and between the network devices. Environment 100 may be implemented to include wired, optical, and/or wireless communication links. A communicative connection via a communication link may be direct or indirect. For example, an indirect communicative connection may involve an intermediary device and/or an intermediary network not illustrated in FIG. 1. A direct communicative connection may not involve an intermediary device and/or an intermediary network. The number, type, and arrangement of communication links illustrated in environment 100 are exemplary.

Environment 100 may include various planes of communication including, for example, a control plane, a user plane, a service plane, and/or a network management plane. Environment 100 may include other types of planes of communication. A message communicated in support of the application and network slice mapping service may use at least one of these planes of communication.

Access network 105 may include one or multiple networks of one or multiple types and technologies. For example, access network 105 may be implemented to include a 5G RAN, a future generation RAN (e.g., a Sixth Generation (6G) RAN, a Seventh Generation (7G) RAN, or a subsequent generation RAN), a centralized-RAN (C-RAN), an Open-RAN (O-RAN), and/or another type of access network. Access network 105 may include a legacy RAN (e.g., a Third Generation (3G) RAN, a 4G or 4.5 RAN, etc.). Access network 105 may communicate with and/or include other types of access networks, such as, for example, a Wi-Fi network, a Worldwide Interoperability for Microwave Access (WiMAX) network, a local area network (LAN), a Citizens Broadband Radio System (CBRS) network, a cloud RAN, a virtualized RAN (vRAN), a self-organizing network (SON), a wired network (e.g., optical, cable, etc.), or another type of network that provides access to or can be used as an on-ramp to access network 105.

Access network 105 may include different and multiple functional splitting, such as options 1, 2, 3, 4, 5, 6, 7, or 8 that relate to combinations of access network 105 and core network 120 including an Evolved Packet Core (EPC) network and/or an NG core (NGC) network, or the splitting of the various layers (e.g., physical layer, media access control (MAC) layer, radio link control (RLC) layer, and packet data convergence protocol (PDCP) layer, etc.), plane splitting (e.g., user plane, control plane, etc.), interface splitting (e.g., F1-U, F1-C, E1, Xn-C, Xn-U, X2-C, Common Public Radio Interface (CPRI), etc.) as well as other types of network services, such as dual connectivity (DC) or higher (e.g., a secondary cell group (SCG) split bearer service, a master cell group (MCG) split bearer, an SCG bearer service, NSA, standalone (SA), etc.), carrier aggregation (CA) (e.g., intra-band, inter-band, contiguous, non-contiguous, etc.), edge and core network slicing, coordinated multipoint (CoMP), various duplex schemes (e.g., frequency division duplex (FDD), time division duplex (TDD), half-duplex FDD (H-FDD), etc.), and/or another type of connectivity service (e.g., NSA new radio (NR), SA NR, etc.).

According to some exemplary embodiments, access network 105 may be implemented to include various architectures of wireless service, such as, for example, macrocell, microcell, femtocell, picocell, metrocell, NR cell, Long Term Evolution (LTE) cell, non-cell, or another type of wireless architecture. Additionally, according to various exemplary embodiments, access network 105 may be implemented according to various wireless technologies (e.g., radio access technologies (RATs), etc.), and various wireless standards, frequencies, bands, and segments of radio spectrum (e.g., centimeter (cm) wave, millimeter (mm) wave, below 6 gigahertz (GHz), above 6 GHz, higher than mm wave, C-band, licensed radio spectrum, unlicensed radio spectrum, above mm wave), and/or other attributes or technologies used for radio communication. According to some exemplary embodiments, access network 105 may be implemented to include various wired and/or optical architectures for wired and/or optical access services.

Depending on the implementation, access network 105 may include one or multiple types of network devices, such as access devices 107. For example, access device 107 may include a next generation Node B (gNB), an enhanced Long Term Evolution (eLTE) evolved Node B (eNB), an eNB, a radio network controller (RNC), a radio intelligent controller (RIC), a base station controller (BSC), a remote radio head (RRH), a baseband unit (BBU), a radio unit (RU), a remote radio unit (RRU), a centralized unit (CU), a CU-control plane (CP), a CU-user plane (UP), a distributed unit (DU), a small cell node (e.g., a picocell device, a femtocell device, a microcell device, a home eNB, a home gNB, etc.), an open network device (e.g., O-RAN Centralized Unit (0-CU), O-RAN Distributed Unit (0-DU), O-RAN next generation Node B (O-gNB), O-RAN evolved Node B (O-eNB)), a 5G ultra-wide band (UWB) node, a future generation wireless access device (e.g., a 6G wireless station, a 7G wireless station, or another generation of wireless station), or another type of wireless node (e.g., a WiFi device, a WiMax device, a hotspot device, a fixed wireless access CPE (FWA CPE), etc.) that provides a wireless access service. Additionally, access devices 107 may include a wired and/or an optical device (e.g., modem, wired access point, optical access point, Ethernet device, multiplexer, etc.) that provides network access and/or transport service.

According to some exemplary implementations, access device 107 may include a combined functionality of multiple RATs (e.g., 4G and 5G functionality, 5G and 5.5G functionality, 5G and 6G), etc.) via soft and hard bonding based on demands and needs. According to some exemplary implementations, access device 107 may include a split access device (e.g., a CU-control plane (CP), a CU-user plane (UP), etc.) or an integrated functionality, such as a CU-CP and a CU-UP, or other integrations of split RAN nodes. Access device 107 may be an indoor device or an outdoor device.

External network 115 may include one or multiple networks of one or multiple types and technologies that provide an end device application service. For example, external network 115 may be implemented using one or multiple technologies including, for example, network function virtualization (NFV), SDN, cloud computing, Infrastructure-as-a-Service (IaaS), Platform-as-a-Service (PaaS), Software-as-a-Service (SaaS), or another type of network technology. External network 115 may be implemented to include a cloud network, a private network, a public network, a multi-access edge computing (MEC) network, a fog network, the Internet, a packet data network (PDN), a service provider network, the World Wide Web (WWW), an Internet Protocol Multimedia Subsystem (IMS) network, a Rich Communication Service (RCS) network, a virtual network, a packet-switched network, a data center, a data network, or other type of application service layer network that may provide access to and may host an end device application service.

Depending on the implementation, external network 115 may include various network devices such as external devices 117. For example, external devices 117 may include virtual network devices (e.g., virtualized network functions (VNFs), servers, host devices, application functions (AFs), application servers (ASs), server capability servers (SCSs), containers, hypervisors, virtual machines (VMs), pods, network function virtualization infrastructure (NFVI), and/or other types of virtualization elements, layers, hardware resources, operating systems, engines, etc.) that may be associated with application services for use by end devices 130. By way of further example, external devices 117 may include mass storage devices, data center devices, NFV devices, SDN devices, cloud computing devices, platforms, and other types of network devices pertaining to various network-related functions (e.g., security, management, charging, billing, authentication, authorization, policy enforcement, development, etc.). Although not illustrated, external network 115 may include one or multiple types of core devices 122, as described herein.

External devices 117 may host one or multiple types of end device application services. For example, the end device application service may pertain to broadband services in dense areas (e.g., pervasive video, smart office, operator cloud services, video/photo sharing, etc.), broadband access everywhere (e.g., 50/100 Mbps, ultra-low-cost network, etc.), enhanced mobile broadband (eMBB), higher user mobility (e.g., high speed train, remote computing, moving hot spots, etc.), Internet of Things (IoT) (e.g., smart wearables, sensors, mobile video surveillance, smart cities, connected home, etc.), extreme real-time communications (e.g., tactile Internet, augmented reality (AR), virtual reality (VR), etc.), lifeline communications (e.g., natural disaster, emergency response, etc.), ultra-reliable communications (e.g., automated traffic control and driving, collaborative robots, health-related services (e.g., monitoring, remote surgery, etc.), drone delivery, public safety, etc.), broadcast-like services, communication services (e.g., email, text (e.g., Short Messaging Service (SMS), Multimedia Messaging Service (MMS), etc.), massive machine-type communications (mMTC), voice, video calling, video conferencing, instant messaging), video streaming, fitness services, navigation services, and/or other types of wireless and/or wired application services. External devices 117 may also include other types of network devices that support the operation of external network 115 and the provisioning of application services, such as an orchestrator, an edge manager, an operations support system (OSS), a local domain name system (DNS), registries, and/or external devices 117 that may pertain to various network-related functions (e.g., security, management, charging, billing, authentication, authorization, policy enforcement, development, etc.). External devices 117 may include non-virtual, logical, and/or physical network devices.

Core network 120 may include one or multiple networks of one or multiple network types and technologies. Core network 120 may include a complementary network of access network 105. For example, core network 120 may be implemented to include a 5G core network, an EPC of an LTE network, an LTE-Advanced (LTE-A) network, and/or an LTE-A Pro network, a future generation core network (e.g., a 5.5G, a 6G, a 7G, or another generation of core network), and/or another type of core network.

Depending on the implementation of core network 120, core network 120 may include diverse types of network devices that are illustrated in FIG. 1 as core devices 122. For example, core devices 122 may include a user plane function (UPF), a Non-3GPP Interworking Function (N3IWF), an access and mobility management function (AMF), a session management function (SMF), a unified data management (UDM), a unified data repository (UDR), an authentication server function (AUSF), a security anchor function (SEAF), a network exposure function (NEF), a network slice selection function (NSSF), a network repository function (NRF), a policy control function (PCF), a network data analytics function (NWDAF), a service capability exposure function (SCEF), a lifecycle management (LCM) device, a mobility management entity (MME), a packet data network (PDN) gateway (PGW), an enhanced packet data gateway (ePDG), a serving gateway (SGW), a home agent (HA), a General Packet Radio Service (GPRS) support node (GGSN), an HSS, an authentication, authorization, and accounting (AAA) server, a policy and charging rules function (PCRF), a policy and charging enforcement function (PCEF), and/or a charging system (CS).

According to other exemplary implementations, core devices 122 may include additional, different, and/or fewer network devices than those described. For example, core devices 122 may include a non-standard or a proprietary network device, and/or another type of network device that may be well-known but not particularly mentioned herein. Core devices 122 may also include a network device that provides a multi-RAT functionality (e.g., 4G and 5G, 5G and 5.5G, 5G and 6G, etc.), such as an SMF with PGW control plane functionality (e.g., SMF+PGW-C), a UPF with PGW user plane functionality (e.g., UPF+PGW-U), and/or other combined nodes (e.g., an HSS with a UDM and/or UDR, an MME with an AMF, etc.). Also, core devices 122 may include a split core device 122. For example, core devices 122 may include a session management (SM) PCF, an access management (AM) PCF, a user equipment (UE) PCF, and/or another type of split architecture associated with another core device 122, as described herein.

End device 130 may include a device that may have computational and communication capabilities (e.g., wireless, wired, optical, etc.). End device 130 may be implemented as a mobile device, a portable device, a stationary device (e.g., a non-mobile device and/or a non-portable device), a device operated by a user, or a device not operated by a user. For example, end device 130 may be implemented as a smartphone, a mobile phone, a personal digital assistant, a tablet, a netbook, a wearable device (e.g., a watch, glasses, headgear, a band, etc.), a computer, a gaming device, a television, a set top box, a music device, an IoT device, a drone, a smart device, a fixed wireless device, a router, a sensor, an automated guided vehicle (AGV), an industrial robot, or other type of wireless device (e.g., other type of UE). End device 130 may be configured to execute various types of software (e.g., applications, programs, etc.). The number and the types of software may vary among end devices 130. End device 130 may include “edge-aware” and/or “edge-unaware” application service clients. For purposes of description, end device 130 is not considered a network device. End device 130 may be implemented as a virtualized device in whole or in part.

According to an exemplary embodiment, end device 130 provides an exemplary embodiment of the application and network slice mapping service, as described herein. According to an exemplary embodiment, end device 130 may include an operating system (OS) and a modem that includes logic of an exemplary embodiment of the application and network slice mapping service. For example, when an application service of end device 130 needs to establish communication with the network, end device 130 may initiate a PDU session setup procedure. End device 130 may select one or multiple network slices based on the URSP information, as described herein. The URSP information may be configured and updated at end device 130 via a configuration procedure with core network 122 (e.g., an AMF) via access network 105 and policies may be provided by a policy core device, such as a PCF, to end device 130. End device 130 may also be pre-provisioned (e.g., on a card, such as a subscriber identification module (SIM), an e-SIM, a universal integrated circuit card (UICC), an embedded UICC, a chip, or the like, or another storage medium) with the URSP information.

According to an exemplary process of an exemplary embodiment of the application and network slice mapping service, a particular end device application executing on the end device may communicate a network request, which may include application information, to the operating system and/or another component of end device 130 (e.g., an application programming interface (API)), as described herein. For example, the operating system (e.g., a kernel or another component of the operating system that may manage data connections) may evaluate the network request based on the URSP information and identify an application category of the connection capabilities traffic descriptor, as described herein. According to an exemplary embodiment, as a part of the traffic descriptor procedure, the operating system may map or correlate application traffic characteristics, which may be included in the network request, to application categories of the connection capabilities traffic descriptor. According to another exemplary embodiment, the network request may include the application categories. For example, the application traffic characteristics may be implemented as application categories (e.g., identical to). According to various exemplary embodiments, the network request may include connection capabilities coding (e.g., a byte value, or another type of string (e.g., alphabetic, numeric, alphanumeric, and the like)) to indicate an application category or an application traffic requirement, as described herein.

The operating system may provide each application category and associated connection capabilities type to the modem. The modem or another component of end device 130 may perform a traffic matching and route selection procedure based on the URSP information. For example, the modem may include selecting a network slice or network slices associated with the route selection descriptors based on the application categories and/or connection capabilities (application categories/connection capabilities) pertaining to the application traffic requirements, as described herein.

According to an exemplary process of an exemplary embodiment of the application and network slice mapping service, the modem or the other component of end device 130 may map the application categories/connection capabilities to 5QI values (e.g., standardized or non-standardized values (e.g., operator specific configurations)). In this way, 5G QoS flows pertaining to each application traffic requirement may be properly supported. According to an exemplary process, the modem or another component may apply a scheduling algorithm for QoS flows, which may have different 5QI values but may be sharing the same network slice, as described herein. For example, well-known scheduling algorithms used in the network may include round-robin (RR), proportional fair queueing, best channel quality indicator (BCQI), fractional frequency reuse (FFR), weighted fair queueing (WFQ), weighted RR, and the like. In this way, end device 130 may transmit traffic of a QoS flow via the network slice in a manner that the QoS flow is afforded proper treatment and achieves its performance requirements.

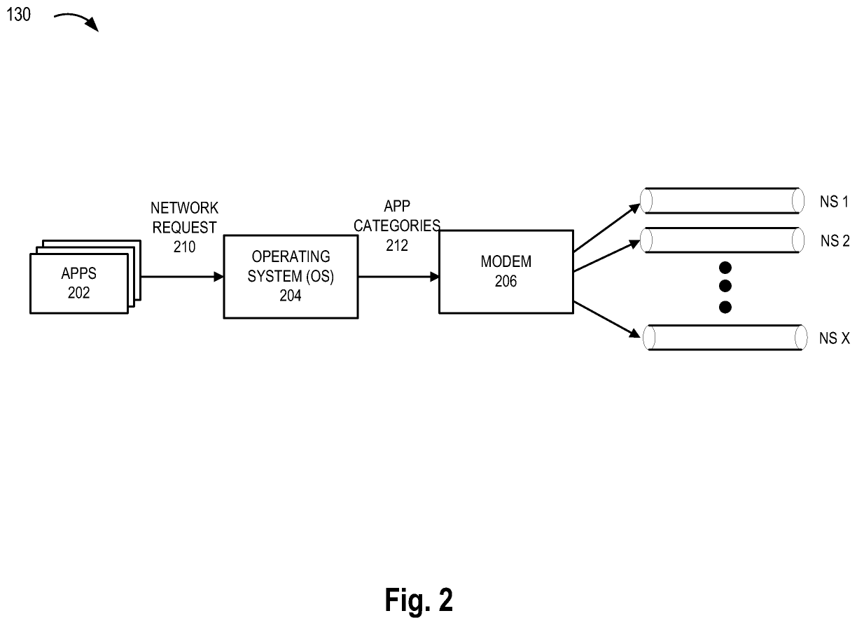

FIG. 2 is a diagram of exemplary components of end device 130 that may provide an exemplary embodiment of the application and network slice mapping service. As illustrated, end device 130 may include applications 202, an operating system 204, and a modem 206. Network slices (NS) 1-NS X and arrows are depicted to support a description of an exemplary process of the application and network slice mapping service. For example, the arrows may represent a communication via a communication link between components (e.g., applications 202 and operating system 204, operating system 204 and modem 206, etc.). The communication link may include a hardware link (e.g., a bus, a shared memory space, etc.), a software link (e.g., inter-process communication (IPC) or the like), an API, or some other type of communicative link that may enable communication between components of end device 130.

Applications 202 may include an end device application hosted by end device 130. For example, the end device application may relate to various types of application services described in relation to external devices 117. For example, applications 202 may include an end device application pertaining to IoT, extreme real-time communications, gaming, voice, video-calling, navigation, ultra-reliable communications, and so forth. The end device application may include a client-side application.

According to an exemplary embodiment, the end device application may include multiple application traffic requirements and/or application categories, as described herein. For example, a single end device application, such as a gaming application, may include different functions or services and correspondingly application traffic requirements and/or application categories, as described herein. By way of further example, a gaming application may include downloading, streaming, interactive communication (e.g., voice and/or video), augmented reality and/or virtual reality, artificial intelligence, multi-player capabilities, and so forth. The application traffic characteristics associated with the functions or services of the gaming application may be mapped to more than one application category of the connection capabilities component of the traffic descriptor included in URSP information, as described herein.

Operating system 204 may be implemented as a Windows®, Linux®, Android®, iOS®, proprietary, or the like. According to an exemplary embodiment, operating system 204 may perform one or more steps, operations, or procedures of an exemplary embodiment of the application and network slice mapping service. For example, operating system 204 may include a kernel or a library that includes logic of an exemplary embodiment of the application and network slice mapping service, as described herein.

Modem 206 may include a component that may perform one or more steps, operations, or procedures of an exemplary embodiment of the application and network slice mapping service. According to various exemplary embodiments, modem 206 may be implemented in or as a modem, a baseband chip, UE Route Selection Policy (URSP) logic, or another element that may enforce URSP rules and/or manage access and/or establishment of network connections by end device 130 with a network (e.g., access network 105, external network 115, core network 120). Modem 206 may include a processor and memory and/or storage.

According to an exemplary process, assume that an application 202 is initiated. For example, a user (not illustrated) may launch application 202 of end device 130 by tapping on an icon of application 202. In response, application 202 may generate a network request 210. According to an exemplary embodiment, network request 210 may include data indicating application traffic requirements or application categories pertaining to application 202. As previously described, the connection capabilities type traffic descriptor may indicate an application category. According to this example, some values may be allocated for operator configuration while other values may indicate a standardized application category.

TABLE 1

| Connection Capabilities Coding | | | | | | | | |
|---|---|---|---|---|---|---|---|---|
| Bits | | | | | | | | |
| 8 | 7 | 6 | 5 | 4 | 3 | 2 | 1 | Application Category |
| 0 | 0 | 0 | 0 | 0 | 0 | 0 | 1 | IMS |
| 0 | 0 | 0 | 0 | 0 | 0 | 1 | 0 | MMS |
| 0 | 0 | 0 | 0 | 0 | 1 | 0 | 0 | SUPL |
| 0 | 0 | 0 | 0 | 1 | 0 | 0 | 0 | Internet |
| 0 | 0 | 1 | 0 | 0 | 0 | 0 | 0 | |
| | | | To | | | | | Operator specific connection capabilities |
| 1 | 0 | 1 | 0 | 0 | 0 | 0 | 0 | |
| 1 | 0 | 1 | 0 | 0 | 0 | 0 | 1 | IoT delay-tolerant |
| 1 | 0 | 1 | 0 | 0 | 0 | 1 | 0 | IoT non-delay-tolerant |
| 1 | 0 | 1 | 0 | 0 | 0 | 1 | 1 | Downlink streaming |
| 1 | 0 | 1 | 0 | 0 | 1 | 0 | 0 | Uplink streaming |
| 1 | 0 | 1 | 0 | 0 | 1 | 0 | 1 | Vehicular communications |
| 1 | 0 | 1 | 0 | 0 | 1 | 1 | 0 | Real time interactive |
| 1 | 0 | 1 | 0 | 0 | 1 | 1 | 1 | Unified communications |
| 1 | 0 | 1 | 0 | 1 | 0 | 0 | 0 | Background |
| 1 | 0 | 1 | 0 | 1 | 0 | 0 | 1 | Mission critical communications |
| 1 | 0 | 1 | 0 | 1 | 0 | 1 | 0 | Time critical communications |
| 1 | 0 | 1 | 0 | 1 | 0 | 1 | 1 | Low latency loss tolerant communications |
| | | | | | | | | in un-acknowledged mode |

All other values are spare. If received, they shall be interpreted as unknown.

The values and application categories presented in Table 1 are merely exemplary. In response to receiving network request 210, when network request 210 includes an application category, operating system 204 may validate the application category based on the URSP information stored. For example, operating system 204 may compare the application category to the stored application categories of the connection capabilities traffic descriptor. For example, network request 210 may include data indicating Internet, downloading, augmented reality, and artificial intelligence, among others in which some may match a standardized application category (e.g., Internet), while other application categories may match operator specific application categories (e.g., augmented reality, artificial intelligence, etc.).

When network request 210 includes an application traffic requirement, operating system 204 may correlate the application traffic requirement to an application category. According to an exemplary embodiment, network request 210 may include agreed upon (e.g., between an application developer/provider associated application 202 and a network operator associated with end device 130, or another entity or entities) signifiers indicating traffic characteristics (e.g., bursty traffic, continuous traffic, etc.), performance metric parameters (e.g., high throughput, low bit rate, etc.) types of sub-services (e.g., health monitoring, industry automation, etc.), and/or other types of attributes pertaining to application 202. According to either approach, operator system 204 may communicate application categories 212 to modem 206.

In response to receiving application categories 212, modem 206 may apply the network slice selection route selection descriptors for selecting a single network slice or multiple network slices. The network slice selection route descriptor may include a single value or a list of values of S-NSSAI(s), such as from NS1 through NS X. According to some exemplary embodiments, network request 210 may include data indicating whether application categories are mapped to a single network slice or multiple network slices are permitted. Operating system 204 may pass the data to modem 206. For example, when a single network slice is selected, all of the application categories are mapped to the same network slice. Alternatively, when multiple network slices may be selected, at least some application categories may be mapped to different network slices based on the network slice selection route selection descriptors information.

According to the exemplary process, modem 206 may also assign 5QIs to the application categories of the network slice. As previously described, modem 206 may use standardized 5QI values (e.g., associated with 3GPP or another standards body) and/or non-standardized values (e.g., 5QI values from 128-254) that may be operator-specific configurations. End device 130 may establish a PDU session and QoS flows via the network slice(s) with external network 115/external device 117 (not illustrated). When multiple application categories share the same network slice, end device 130, modem 206, and/or a communication interface (not illustrated) may apply a scheduling algorithm for transmission of data/traffic, as described herein.

FIG. 2 illustrates exemplary components that may provide an exemplary embodiment of the application and network slice mapping service, however according to other exemplary embodiments, additional, fewer, and/or different components may be implemented. For example, a single component/device may be implemented as multiple components/devices and/or multiple components/devices may be implemented as a single component/device.

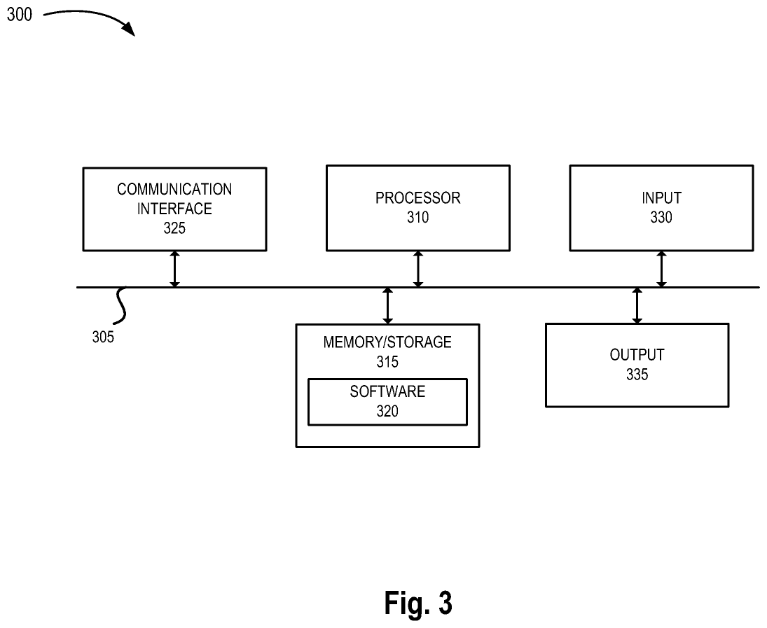

FIG. 3 is a diagram illustrating exemplary components of a device 300 that may be included in one or more of the devices described herein. For example, device 300 may correspond to access device 107, external device 117, core device 122, end device 130, and/or other types of devices, as described herein. As illustrated in FIG. 3, device 300 includes a bus 305, a processor 310, a memory/storage 315 that stores software 320, a communication interface 325, an input 330, and an output 335. According to other embodiments, device 300 may include fewer components, additional components, different components, and/or a different arrangement of components than those illustrated in FIG. 3 and described herein.

Bus 305 includes a path that permits communication among the components of device 300. For example, bus 305 may include a system bus, an address bus, a data bus, and/or a control bus. Bus 305 may also include bus drivers, bus arbiters, bus interfaces, clocks, and so forth.

Processor 310 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), and/or some other type of component that interprets and/or executes instructions and/or data. Processor 310 may be implemented as hardware (e.g., a microprocessor, etc.), a combination of hardware and software (e.g., a SoC, an ASIC, etc.), may include one or multiple memories (e.g., cache, etc.), etc.

Processor 310 may control the overall operation, or a portion of operation(s) performed by device 300. Processor 310 may perform one or multiple operations based on an operating system and/or various applications or computer programs (e.g., software 320). Processor 310 may access instructions from memory/storage 315, from other components of device 300, and/or from a source external to device 300 (e.g., a network, another device, etc.). Processor 310 may perform an operation and/or a process based on various techniques including, for example, multithreading, parallel processing, pipelining, interleaving, learning, model-based, etc.

Memory/storage 315 includes one or multiple memories and/or one or multiple other types of storage mediums. For example, memory/storage 315 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM), a single in-line memory module (SIMM), a dual in-line memory module (DIMM), a flash memory (e.g., 2D, 3D, NOR, NAND, etc.), a solid state memory, and/or some other type of memory. Memory/storage 315 may include a hard disk (e.g., a magnetic disk, an optical disk, a magneto-optic disk, a solid-state component, etc.), a Micro-Electromechanical System (MEMS)-based storage medium, and/or a nanotechnology-based storage medium.

Memory/storage 315 may be external to and/or removable from device 300, such as, for example, a Universal Serial Bus (USB) memory stick, a dongle, a hard disk, mass storage, off-line storage, or some other type of storing medium. Memory/storage 315 may store data, software, and/or instructions related to the operation of device 300.

Software 320 includes an application or a program that provides a function and/or a process. As an example, with reference to end device 130, software 320 may include an application that, when executed by processor 310, provides a function and/or a process of the application and network slice mapping service, as described herein. Software 320 may also include firmware, middleware, microcode, hardware description language (HDL), and/or another form of instruction. Software 320 may also be virtualized. Software 320 may further include an operating system (OS) (e.g., Windows, Linux, Android, proprietary, etc.), such as operating system 204. Software 320 may include applications 202.

Communication interface 325 permits device 300 to communicate with other devices, networks, systems, and/or the like. Communication interface 325 includes one or multiple wireless interfaces, optical interfaces, and/or wired interfaces. For example, communication interface 325 may include one or multiple transmitters and receivers, or transceivers. Communication interface 325 may operate according to a protocol stack and a communication standard. Communication interface 325 may include modem 206.

Input 330 permits an input into device 300. For example, input 330 may include a keyboard, a mouse, a display, a touchscreen, a touchless screen, a button, a switch, an input port, speech recognition logic, and/or some other type of visual, auditory, tactile, affective, olfactory, etc., input component. Output 335 permits an output from device 300. For example, output 335 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, PaaS, etc.). Device 300 may be implemented in the same manner. For example, device 300 may be instantiated, created, deleted, or some other operational state during its life-cycle (e.g., refreshed, paused, suspended, rebooted, or another type of state or status), using well-known virtualization technologies. For example, access device 107, core device 122, external device 117, and/or another type of network device or end device 130, as described herein, may be a virtualized device.

Device 300 may be configured to perform a process and/or a function, as described herein, in response to processor 310 executing software 320 stored by memory/storage 315. By way of example, instructions may be read into memory/storage 315 from another memory/storage 315 (not shown) or read from another device (not shown) via communication interface 325. The instructions stored by memory/storage 315 cause processor 310 to perform a function, an operation, or a process described herein. Alternatively, for example, according to other implementations, device 300 may be configured to perform a function, an operation, or a process described herein based on the execution of hardware (processor 310, etc.).

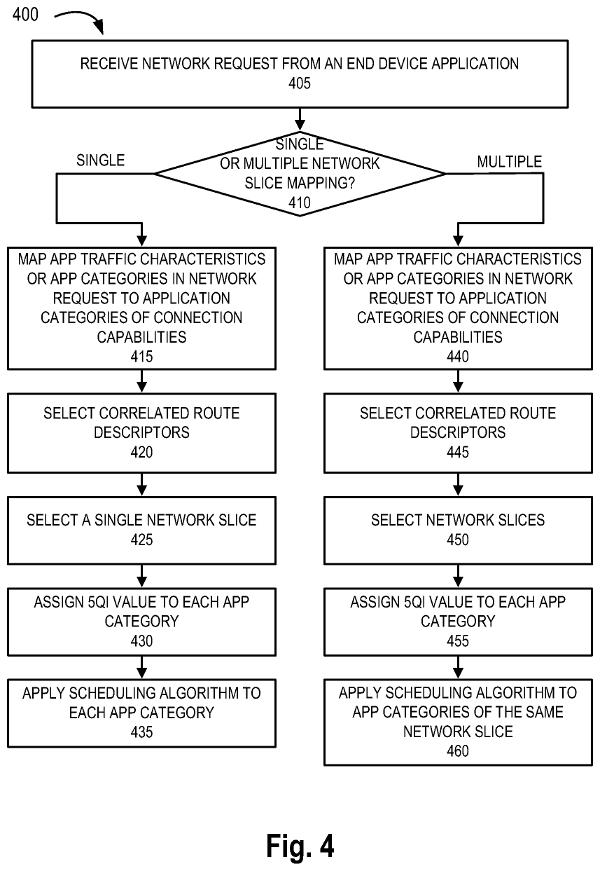

FIG. 4 is a flow diagram illustrating an exemplary process 400 of an exemplary embodiment of the application and network slice mapping service. According to an exemplary embodiment, end device 130 may perform operations of process 400. According to an exemplary implementation, processor 310 executes software 320 to perform a step (in whole or in part) of process 400, as described herein. Alternatively, a step (in whole or in part) may be performed by execution of only hardware. Process 400 may include an operation illustrated and described in relation to FIG. 2, and elsewhere in this description.

In block 405, an end device may receive a network request from an application. For example, an end device application, such as application 202, which is hosted on end device 130, may be launched and may issue a network request. The operating system of end device 130 may receive the network request. The network request may include application information, such as application traffic characteristics and/or application categories, as described herein.

In block 410, the end device may determine whether single or multiple network slicing is used. According to some exemplary embodiments, end device 130 may make this determination (e.g., a binary choice) based on data (e.g., a flag, a value, or the like) included in the network request. According to some exemplary embodiments, end device 130 may make this determination based on context information (e.g., current or prospective network congestion states in access network 105, external network 115, and/or core network 120), subscription information (e.g., tier of wireless service) pertaining to end device 130 and/or a user of end device 130.

In block 410-SINGLE, when the end device determines that single network slice mapping is to be used, the end device may map application traffic characteristics or application categories indicated in the network request to application categories of connection capabilities traffic descriptors, as described herein (block 415). For example, the operating system may use the URSP information to correlate the application traffic characteristics to the application categories of the URSP information or match the application categories to the application categories of the URSP information. The operating system may provide the application categories to a modem or similar component of the end device, as described herein.

In block 420, the end device may select correlated route descriptors. For example, the modem or the like may map or correlate each application category to network slice selection information of the route selection descriptors included in the URSP information, as described herein.

In block 425, the end device may select a single network slice for the application categories based on the mapping, as described herein. For example, the mapped network slice selection information may indicate an S-NSSAI from which end device 130 may select.

In block 430, the end device may assign 5QI values to each application category, as described herein. For example, end device 130 may select 5QI values, which may be standardized and/or non-standardized (e.g., operator-specific), as described herein.

In block 435, the end device may apply a scheduling algorithm to each application category that shares the network slice. For example, the transmission of traffic associated with each QoS flow and application category may be subject to the scheduling algorithm (e.g., RR, PFQ, etc.) during a PDU session with external device 117.

In block 410-MULTIPLE, when the end device determines that multiple network slice mapping is to be used, the end device may map application traffic characteristics or application categories indicated in the network request to application categories of connection capabilities traffic descriptors, as described herein (block 440).

In block 445, the end device may select correlated route descriptors. For example, the modem or the like may map or correlate each application category to network slice selection information of the route selection descriptors included in the URSP information, as described herein.

In block 450, the end device may select network slices for the application categories based on the mapping, as described herein. For example, the mapped network slice selection information may indicate an S-NSSAI from which end device 130 may select. By way of further example, a first set of multiple application categories may be assigned to a first network slice, and one or more other application categories may be assigned to a corresponding one or more second network slice(s).

In block 455, the end device may assign 5QI values to each application category, as described herein. For example, end device 130 may select 5QI values, which may be standardized and/or non-standardized (e.g., operator-specific), as described herein.

In block 460, the end device may apply a scheduling algorithm to each application category that shares the same network slice. For example, the transmission of traffic associated with the QoS flows and application categories of the first network slice may be subject to the scheduling algorithm (e.g., RR, PFQ, etc.) during a PDU session with external device 117. Additionally, for example, for an application category with its own network slice, such as a second network slice, the transmission of traffic associated with the QoS flow may not be subject to the scheduling algorithm.

FIG. 4 illustrates an exemplary process 400 of the application and network slice mapping service, however, according to other exemplary embodiments, the application and network slice mapping service may perform additional operations, fewer operations, and/or different operations than those illustrated and described in relation to FIG. 4. For example, according to some exemplary embodiments, block 410 may be omitted. For example, end device 130 may be configured to map all network requests to a single network slice. According to another example, end device 130 may be configured to map all network requests to multiple network slices when a set of application categories (i.e., multiple application categories that may differ) map to the same network slice. According to some exemplary embodiments, available connection capabilities traffic descriptors and/or route descriptors for the single network slice option may differ relative to available connection capabilities traffic descriptors and/or route descriptors for the multiple network slices option.

As set forth in this description and illustrated by the drawings, reference is made to “an exemplary embodiment,” “exemplary embodiments,” “an embodiment,” “embodiments,” etc., which may include a particular feature, structure, or characteristic in connection with an embodiment(s). However, the use of the phrase or term “an embodiment,” “embodiments,” etc., in various places in the description does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/of” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while a series of blocks have been described regarding the process illustrated in FIG. 4, the order of the blocks may be modified according to other embodiments. Further, non-dependent blocks may be performed in parallel. Additionally, other processes described in this description may be modified and/or non-dependent operations may be performed in parallel.

Embodiments described herein may be implemented in many different forms of software executed by hardware. For example, a process or a function may be implemented as “logic,” a “component,” or an “element.” The logic, the component, or the element, may include, for example, hardware (e.g., processor 310, etc.), or a combination of hardware and software (e.g., software 320).

Embodiments have been described without reference to the specific software code because the software code can be designed to implement the embodiments based on the description herein and commercially available software design environments and/or languages. For example, diverse types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 310) of a device. A non-transitory storage medium includes one or more of the storage mediums described in relation to memory/storage 315. The non-transitory computer-readable storage medium may be implemented in a centralized, distributed, or logical division that may include a single physical memory device or multiple physical memory devices spread across one or multiple network devices.

To the extent the aforementioned embodiments collect, store, or employ personal information of individuals, it should be understood that such information shall be collected, stored, and used in accordance with all applicable laws concerning protection of personal information. Additionally, the collection, storage and use of such information can be subject to the consent of the individual to such activity, for example, through well known “opt-in” or “opt-out” processes as can be appropriate for the situation and type of information. Collection, storage, and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such.

All structural and functional equivalents to the elements of the various aspects set forth in this disclosure that are known or later come to be known are expressly incorporated herein by reference and are intended to be encompassed by the claims.

What is claimed is:

1. A method comprising:
receiving, by an end device, a network request from an end device application hosted at the end device;
mapping, by the end device based on the network request, application categories included in user equipment route selection policy (URSP) information;
selecting, by the end device based on the mapping, one or multiple network slices;
assigning, by the end device, quality of service (QoS) identifier values for each of the application categories; and
applying, by the end device, a scheduling algorithm for each of the application categories that are assigned to a same network slice of the one or multiple network slices.

2. The method of claim 1, further comprising:
transmitting, by the end device based on the applying, traffic to an application server during a packet data unit (PDU) session.

3. The method of claim 1, further comprising:
determining, by the end device, whether multiple network slices can be selected based on data included in the network request.

4. The method of claim 1, wherein the application categories are indicated in connection capabilities traffic descriptors of the URSP information.

5. The method of claim 1, wherein the one or multiple network slices are indicated in network slice selection route descriptors of the URSP information.

6. The method of claim 1, wherein the application categories include two or more application categories that are operator specific.

7. The method of claim 1, wherein the network request includes data indicating application categories.

8. The method of claim 1, wherein the network request includes data indicating application traffic characteristics, and the method further comprises:
correlating, by the end device, the application traffic characteristics to the application categories of the URSP information.

9. An end device comprising:
a communication interface; and
a processor, wherein the processor is configured to:
receive a network request from an end device application hosted at the end device;
map, based on the network request, application categories included in user equipment route selection policy (URSP) information;
select, based on the mapping, one or multiple network slices;
assign quality of service (QoS) identifier values for each of the application categories; and
apply a scheduling algorithm for each of the application categories that are assigned to a same network slice of the one or multiple network slices.

10. The end device of claim 9, wherein the processor is further configured to:
transmit, based on the applying, traffic to an application server during a packet data unit (PDU) session.

11. The end device of claim 9, wherein the processor is further configured to:
determine whether multiple network slices can be selected based on data included in the network request.

12. The end device of claim 9, wherein the application categories are indicated in connection capabilities traffic descriptors of the URSP information.

13. The end device of claim 9, wherein the one or multiple network slices are indicated in network slice selection route descriptors of the URSP information.

14. The end device of claim 9, wherein the application categories include two or more application categories that are operator specific.

15. The end device of claim 9, wherein the application categories include two or more application categories that are operator specific.

16. The end device of claim 9, wherein the network request includes data indicating application traffic characteristics, and the processor is further configured to:
correlate the application traffic characteristics to the application categories of the URSP information.

17. A non-transitory computer-readable storage medium storing instructions executable by a processor of an end device, wherein the instructions are configured to:
receive a network request from an end device application hosted at the end device;
map, based on the network request, application categories included in user equipment route selection policy (URSP) information;
select, based on the mapping, one or multiple network slices;
assign quality of service (QoS) identifier values for each of the application categories; and
apply a scheduling algorithm for each of the application categories that are assigned to a same network slice of the one or multiple network slices.

18. The non-transitory computer-readable storage medium of claim 17, wherein the instructions are further configured to:
transmit, based on the applying, traffic to an application server during a packet data unit (PDU) session.

19. The non-transitory computer-readable storage medium of claim 17, wherein the instructions are further configured to:
determine whether multiple network slices can be selected based on data included in the network request.

20. The non-transitory computer-readable storage medium of claim 17, wherein the application categories are indicated in connection capabilities traffic descriptors of the URSP information.
